(19) United States
(12) Patent Application Publication
(10) Pub. No.: US 2005/0086449 A1
(43) Pub. Date: Apr. 21, 2005

(54) Method and apparatus for managing memory

(75) Inventor: Alexei Zavitaev, Suwon-si (KR)

Correspondence Address: STAAS & HALSEY LLP, SUITE 700, 1201 NEW YORK AVENUE, N.W., WASHINGTON, DC, 20005, US

(73) Assignee: Samsung Electronics Co., Ltd., Suwon-si (KR)

(21) Appl. No.: 10/918,750

(22) Filed: Aug. 16, 2004

(30) Foreign Application Priority Data
Aug. 16, 2003 (KR) 2003-56726

(51) Int. Cl. G06F 12/00

(52) U.S. Cl. 711/170

(57) ABSTRACT

A method and apparatus managing a memory, the method includes determining whether allocation or cancellation of a predetermined section of the memory as a memory block is made; and when determined that the predetermined section of the memory is allocated as the memory block or an already-allocated memory block is canceled, managing index information regarding the remaining sections of the memory using a height-balanced binary tree and returning to determining whether the allocation or cancellation of the predetermined section of the memory as the memory block is made. Accordingly, it is possible to manage index information regarding a memory block using the height-balanced binary tree faster than sequential information management.

### CROSS-REFERENCE TO RELATED APPLICATION

This application claims the priority of Korean Patent Application No. 2003-56726 filed on Aug. 16, 2003 in the Korean Intellectual Property Office, the disclosure of which is incorporated herein by reference.

### BACKGROUND OF THE INVENTION

1. Field of the Invention

The present invention relates to the management of a memory installed in an electronic appliance such as a computer, and more particularly, to a method and apparatus managing index information regarding a memory block using a height-balanced binary tree.

2. Description of the Related Art

One main function of an operating system of an electronic appliance, such as a computer, is to manage a memory installed therein by controlling allocation of a physical memory storage space for implementing a process therein. In particular, for multiprocessing, the operating system manages a relationship between a physical memory space and a logical memory space for each process. Memory management may be classified into a linked list type, a stacked type, and a queue type.

In the linked list type memory management, lists of respective data regarding memory allocation are linked to one another for memory management. The data regarding memory allocation is stored in units referred to as nodes.

In the stacked type memory management, data regarding memory allocation is output in reverse order that the data is input. That is, the latest input data regarding memory allocation is output first and the earliest input data regarding memory allocation is output last. The stacked type memory management is also referred to as a last-in first-out (LIFO) type.

In the queue type memory management, data regarding memory allocation is output in the order that the data is input. That is, the earliest input data is output first and the latest input data is output last. The queue type memory management is referred to as a first-in first-out (FIFO) type.

The above memory management is, however, disadvantageous in that desired data regarding memory allocation is output by searching all data regarding memory allocation, thus requiring a lot of time for memory management.

### SUMMARY OF THE INVENTION

According to an aspect of the present invention there is provided a memory management method in which index information regarding memory blocks are managed using a height-balanced binary tree.

According to another aspect of the present invention there is provided a memory management apparatus capable of managing index information regarding memory blocks using the height-balanced binary tree.

According to an aspect of the present invention, there is provided a method of managing a memory installed in an electronic appliance, the method including determining whether allocation or cancellation of a predetermined section of the memory as a memory block is made; and when determined that the predetermined section of the memory is allocated as a memory block or an already-allocated memory block is canceled, using a height-balanced binary tree to manage index information regarding the remaining sections of the memory and returning to determining whether the allocation or cancellation of a predetermined section of the memory as a member block is made.

According to another aspect of the present invention, there is provided an apparatus managing a memory installed in an electronic appliance, the apparatus including a memory allocation determination unit which determines whether allocation or cancellation of a predetermined section of the memory as a memory block is made; and a tree managing unit which manages index information regarding the remaining sections of the memory using a height-balanced binary tree.

According to another aspect of the invention, there is provided a computer readable medium encoded with processing instructions performing a method of managing memory, the method includes determining whether allocation or cancellation of a predetermined section of the memory as a memory block is made; and when determined that the predetermined section of the memory is allocated as the memory block or when an already-allocated memory block is canceled, using a height-balanced binary tree to index information regarding the remaining sections of the memory and returning to determining whether the allocation or cancellation of the predetermined section of the memory as the memory block is made.

Additional aspects and/or advantages of the invention will be set forth in part in the description which follows and, in part, will be obvious from the description, or may be learned by practice of the invention.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 is a flowchart illustrating a memory management method according to an embodiment of the present invention;

FIG. 2 illustrates a memory map regarding states of the remaining sections of a memory when predetermined sections of the memory are allocated as memory blocks, according to an embodiment of the present invention;

FIG. 3 illustrates a height-balanced binary tree of index information regarding the remaining sections of a memory when predetermined sections of the memory are allocated as memory blocks, according to an embodiment of the present invention; and

FIG. 4 is a block diagram of a memory management apparatus according to an embodiment of the present invention.

### DETAILED DESCRIPTION OF THE EMBODIMENTS

Reference will now be made in detail to the embodiments of the present invention, examples of which are illustrated in the accompanying drawings, wherein like reference numerals refer to the like elements throughout. The embodiments are described below to explain the present invention by referring to the figures.

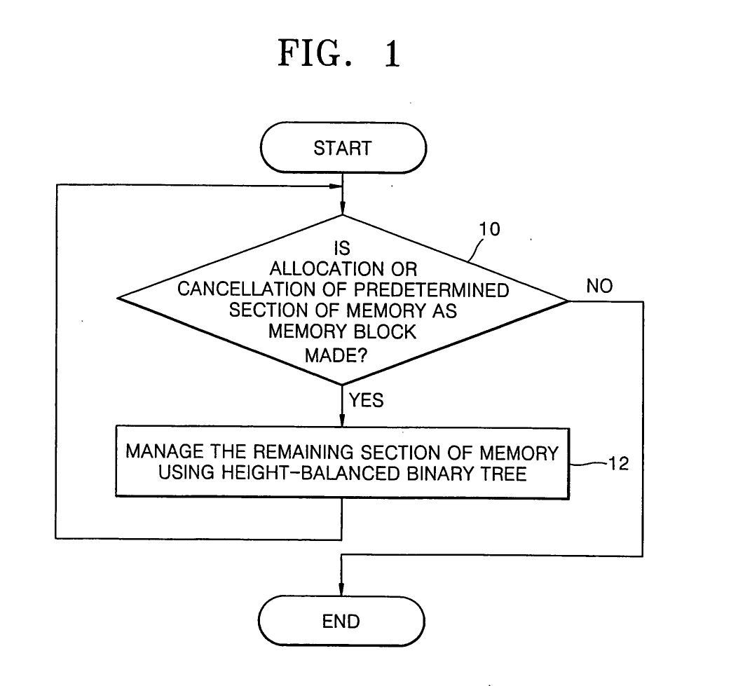

FIG. 1 is a flowchart illustrating a memory management method in which sections, of a memory, which remain after allocation or cancellation of a predetermined section of the memory as a memory block, are managed using a height-balanced binary tree (operations 10 through 12), according to an embodiment of the present invention.

More specifically, whether allocation or cancellation of the predetermined section of the memory as a memory block is made is determined (operation 10). For instance, when a predetermined section is not allocated as a memory block or when the already-allocated memory block is not canceled, the memory management method ends.

When the predetermined section is allocated as a memory block or the already-allocated memory block is canceled, index information regarding the remaining sections which are not allocated as memory blocks are managed using the height-balanced binary tree (operation 12). Next, returning to operation 10, the memory management method is repeatedly performed.

A binary tree is a data structure in which index information expressed with nodes (called root nodes) are arranged as branches of a tree so that they are linked to each other. That is, the binary tree consists of sub trees, a root node of each sub tree branching out into 0, 1, or 2 child nodes. In particular, the height-balanced binary tree is a data structure in which right and left sub trees are height-balanced so that their heights are equal to each other. The height-balanced binary tree is also referred to as the Adelson Velskii Landis (AVL) tree. Index information specifies indexes, e.g., a memory size and block address, regarding the other sections of the memory.

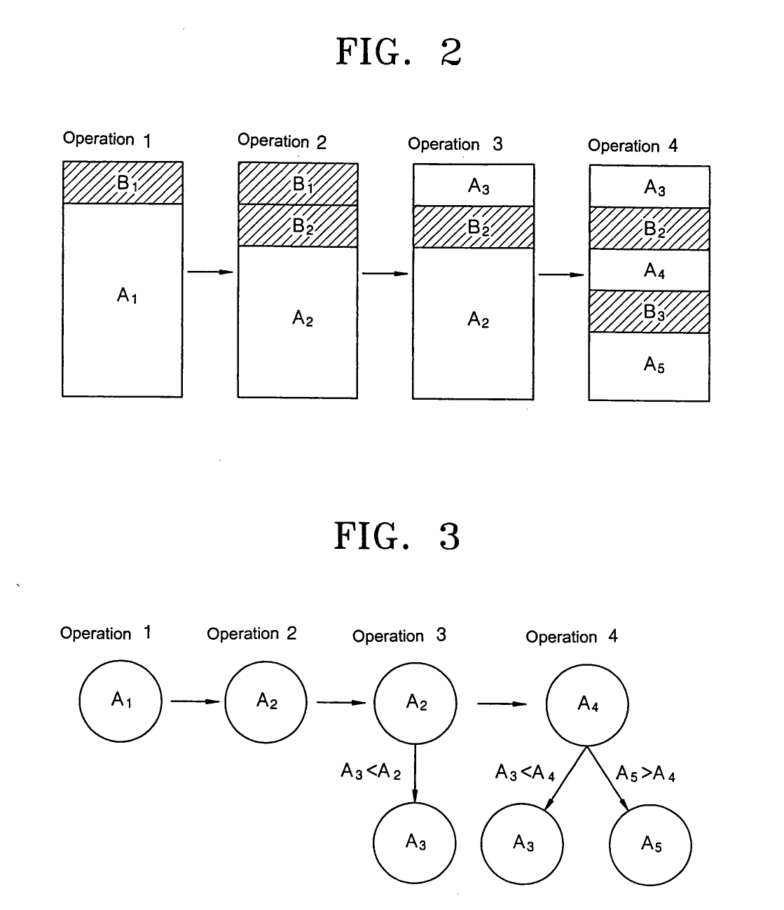

FIG. 2 illustrates a memory map regarding states of remaining sections of a memory when predetermined sections of the memory are allocated as memory blocks, according to an embodiment of the present invention.

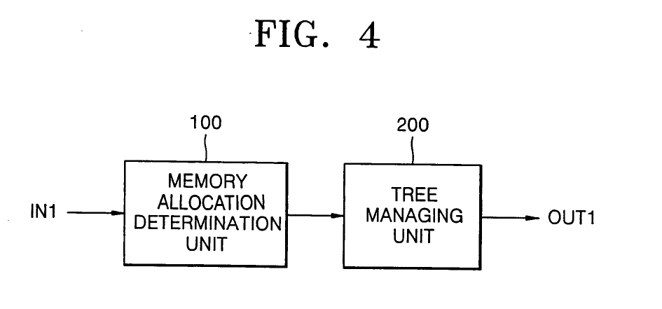

FIG. 3 illustrates a height-balanced binary tree of index information regarding remaining sections of a memory when predetermined sections of the memory are allocated as memory blocks, according to an embodiment of the present invention.

Operation 1 of FIGS. 2 and 3 shows a memory map and a height-balanced binary tree, respectively, when the method of FIG. 1 is performed for a first time. In operation 1 of FIG. 2, B₁ denotes a memory map of a predetermined section of a memory that is allocated as a first memory block, and A₁ denotes a memory map of a first remaining section of the memory. In this case, as shown in operation 1 of FIG. 3, index information regarding the first remaining section A₁ becomes a root node of the height-balanced binary tree.

Operation 2 of FIGS. 2 and 3 shows a memory map and a height-balanced binary tree, respectively, when the method of FIG. 1 is performed for a second time. In operation 2 of FIG. 2, B₂ denotes a memory map of a predetermined section of the first remaining section A₁ that is allocated as a second memory block, and A₂ denotes a memory map of a second remaining section that remains by subtracting the second memory block B₂ from the first remaining section A₁. In this case, as shown in operation 2 of FIG. 3, index information regarding the first remaining section A₁ is replaced with the index information regarding the second remaining section A₂ as the root node of the height-balanced binary tree.

Operation 3 of FIGS. 2 and 3 shows a memory map and a height-balanced binary tree, respectively, when the method of FIG. 1 is performed for a third time. In operation 3 of FIG. 2, the first memory block B₁ is canceled and thus is replaced with a third remaining section A₃.

In this case, as shown in operation 3 of FIG. 3, index information regarding the third remaining section A₃ becomes a left child node of the root node, i.e., the second remaining section A₂, since a size of the third remaining section A₃ is smaller than that of the second remaining section A₂.

Operation 4 of FIGS. 2 and 3 shows a memory map and a height-balanced binary tree, respectively, when the method of FIG. 1 is performed for a fourth time. As shown in operation 4 of FIG. 2, a middle part of the second remaining section A₂ is allocated as a third memory block B₃. As a result, the second remaining section A₂ is divided into three parts: a fourth remaining section A₄, the third memory block B₃, and a fifth remaining section A₅.

In this case, as shown in operation 4 of FIG. 3, the index information regarding the second remaining section A₂ is replaced with the fourth remaining section A₄ as the root node of the height-balanced binary tree, and index information regarding the third and fifth remaining sections A₃ and A₅ become child nodes. Since the size of the third remaining section A₃is smaller than that of the fourth remaining section A₄, the third remaining section A₃ becomes a left child node of the fourth remaining section A₄. Also, since a size of the fifth remaining section A₅ is larger than that of the fourth remaining section A₄, the fifth remaining section A₅ becomes a right child node of the fourth remaining section A₄.

The present invention is not limited to the above description. That is, a method of dividing a memory into several blocks and a shape of the height-balanced binary tree are not limited to the above description.

A structure of a memory management apparatus according to an embodiment of the present invention will now be described with reference to FIG. 4. The memory management apparatus of FIG. 4 includes a memory allocation determination unit 100 and a tree managing unit 200.

The memory allocation determination unit 100 determines whether allocation or cancellation of a predetermined section of a memory is made or not. When a signal indicating such a change in allocation of the memory is input to the memory allocation determination unit 100 via an input terminal IN1, the memory allocation determination unit 100 transmits the signal to the tree managing unit 200.

In response to the signal input from the memory allocation determination unit 100, the tree managing unit 200 manages index information regarding sections of the memory, which remain after the change in the allocation of the memory, using the height-balanced binary tree and transmits a result of managing to an output terminal OUT1.

For instance, the tree managing unit 200 manages index information regarding the remaining sections of the memory using the height-balanced binary tree when a predetermined section of the memory is allocated as a memory block, as shown in FIGS. 2 and 3. Accordingly, it is possible to search for desired information faster than sequential information management.

As described above, in a memory management method and apparatus according to the present invention, it is possible to manage index information regarding a memory block using the height-balanced binary tree faster than sequential information management.

The aforementioned method of managing memory may be embodied as a computer program that can be run by a computer, which can be a general or special purpose computer. Thus, it is understood that the apparatus of managing memory can be such a computer. Computer programmers in the art can easily reason codes and code segments, which constitute the computer program. The program is stored in a computer readable medium readable by the computer. When the program is read and run by a computer, the method of controlling the display apparatus is performed. Here, the computer-readable medium may be a magnetic recording medium, an optical recording medium, a carrier wave, firmware, or other recordable media.

While this invention has been particularly shown and described with reference to embodiments thereof, it will be understood by those skilled in the art that various changes in form and details may be made therein without departing from the spirit and scope of the invention as defined by the appended claims.

1. A method of managing a memory installed in an electronic appliance, the method comprising:
determining whether allocation or cancellation of a predetermined section of the memory as a memory block is made; and
when determined that the predetermined section of the memory is allocated as the memory block or when an already-allocated memory block is canceled, using a height-balanced binary tree to index information regarding remaining sections of the memory and returning to determining whether the allocation or cancellation of the predetermined section of the memory as the memory block is made.

2. The method of claim 1, wherein the determination of whether the predetermined section of the memory is allocated comprises managing index information according to sizes of remaining sections of the memory.

3. The method of claim 1, wherein the height-balanced binary tree is a data structure having right and left sub trees having heights equal to each other.

4. An apparatus managing a memory installed in an electronic appliance, the apparatus comprising:
a memory allocation determination unit determining whether allocation or cancellation of a predetermined section of the memory as a memory block is made; and
a tree managing unit managing index information regarding remaining sections of the memory using a height-balanced binary tree.

5. The apparatus of claim 4, wherein the tree managing unit manages index information according to sizes of the remaining sections of the memory.

6. The apparatus of claim 4, wherein the height-balanced binary tree is a data structure having right and left sub trees having heights equal to each other.

7. The apparatus of claim 4, wherein the memory allocation determination unit transmits a signal to the tree managing unit, when a signal indicating whether the allocation or cancellation of the predetermined section of the memory is made.

8. The apparatus of claim 7, wherein the tree managing unit manages the index information regarding the remaining sections of the memory using the height-balanced binary tree in response to the signal transmitted from the memory allocation determination unit.

9. The apparatus of claim 8, wherein the tree managing unit manages the index information regarding the remaining section of the memory using the height-balanced binary tree when the predetermined section of the memory is allocated as the memory block.

10. A computer readable medium encoded with processing instructions performing a method of managing a memory, the method comprising:
determining whether allocation or cancellation of a predetermined section of the memory as a memory block is made; and
when determined that the predetermined section of the memory is allocated as the memory block or when an already-allocated memory block is canceled, using a height-balanced binary tree to index information regarding the remaining sections of the memory and returning to determining whether the allocation or cancellation of the predetermined section of the memory as the memory block is made.

11. The computer readable medium of claim 10, wherein the determination of whether the predetermined section of the memory is allocated comprises managing index information according to sizes of the remaining sections of the memory.

12. The computer readable medium of claim 10, wherein the height-balanced binary tree is a data structure having right and left sub trees having heights equal to each other.
